(19) United States
(12) Patent Application Publication
(10) Pub. No.: US 2018/0035621 A1
(43) Pub. Date: Feb. 8, 2018

(54) Target Watering And Irrigation Apparatus

(71) Applicant: Wow Product Sales, LLC, Fenton, MI (US)

(72) Inventor: David M. Allen, Fenton, MI (US)

(21) Appl. No.: 15/670,048

(22) Filed: Aug. 7, 2017

Related U.S. Application Data
(60) Provisional application No. 62/371,255, filed on Aug. 5, 2016.

(51) Int. Cl. A01G 25/06

(52) U.S. Cl. CPC A01G 25/06

(57) ABSTRACT

A target watering an irrigation apparatus comprising an elongated tube and a cap member. The elongated tube has an outer surface and an inner bore. The cap member is positioned over the upper end of the inner bore. The cap member has at least one opening in communication with the inner bore.

### CROSS-REFERENCE TO RELATED APPLICATION

The present application claims priority from U.S. Pat. App. Ser. No. 62/371,255 filed Aug. 5, 2016, entitled “Target Watering And Irrigation Apparatus,” the entire disclosure of which is hereby incorporated by reference in its entirety.

### BACKGROUND OF THE DISCLOSURE

### 1. Field of the Disclosure

The disclosure relates in general to lawn and garden care equipment, and more particularly, to a target watering an irrigation apparatus which aids in the delivery of nutrients, oxygen and water (among other desirable fluids and gasses) to the root system of a bush, shrub, tree or other plant.

### 2. Background Art

It is known that many soils in urban areas are severely compacted, especially around plants and the like. With such compacted soil, it is often difficult for water, oxygen and nutrients to pass through the soil to the root systems of the plants. Without access and availability of these nutrients, water and oxygen, the growth of a plant can be stifled, and the health of the plant can be detrimentally affected.

Certain solutions have been developed in an effort to improve the transmission of these beneficial fluids and gasses more directly to the root system of a plant. Among other solutions, watering and aeration tubes have been developed. These tubes, however, have drawbacks. Among other drawbacks, such aeration tubes can become clogged, especially by dirt forced into the openings when the tubes are inserted in the soil. Additionally, soil around the tube may remain compacted, which further limits the additional functionality.

### SUMMARY OF THE DISCLOSURE

The disclosure is directed to a target watering and irrigation apparatus that includes an elongated tube and a cap member. The elongated tube has an outer surface and an inner bore. The cap member is positioned over the upper end of the inner bore, the cap member having at least one opening in communication with the inner bore.

In some configurations, the elongated tube further includes an upper end and a lower end, with a bulb portion positioned at the lower end and a shaft portion positioned between the bulb portion and the upper end.

In some configurations, the shaft portion includes at least one pane that has openings. The bulb portion has an outer surface that extends radially beyond at least a portion of the pane having openings.

In some configurations, the shaft portion includes at least one longitudinal support rib extending along the shaft portion between the bulb portion and the upper end. The at least one longitudinal support rib has opposing side walls projecting outwardly from the at least one pane.

In some configurations, the shaft portion includes a plurality of longitudinal support ribs positioned in a spaced apart relationship.

In some configurations, the bulb portion includes a plurality of openings. The openings of the pane are larger than the openings of the bulb portion.

In some configurations, the bulb portion includes at least one transverse channel opposed by raised transverse ribs. The plurality of openings extend through the at least one transverse channel.

In some configurations, a lower spike portion is positioned between the bulb portion and the lower end.

In some configurations, the bulb portion includes an inflection point that is spaced apart from the lower end and spaced apart from the lower spike portion.

In some configurations, the cap member further comprises a top plate that is generally perpendicular to an axis defined by the elongated tube. A depending skirt is structurally configured to matingly interface with the elongated tube proximate the upper end thereof with the top plate having a plurality of openings extending therethrough to provide ingress into the elongated tube.

In some configurations, the top plate extends radially outwardly beyond the depending skirt.

In some configurations, the depending skirt extends about the outer surface of the elongated tube.

In some configurations, the elongated tube further includes a flange space apart from the upper end thereof and extending axially outward from the outer surface thereof. The flange abuts a lower rim of the depending skirt, limiting further slidable movement thereof relative to the elongated tube.

In some configurations, the cap member is releasably coupled to the elongated tube to as to preclude relative axial movement.

In some configurations, the cap member further includes an inward pin that is interfaceable with a transverse slot in the elongated tube.

In some configurations, the cap further comprises an upper cover. In such a configuration, the cap member further has an upstanding perimeter wall and at least one of a transverse slot and an entry channel. The upstanding perimeter wall extendings upwardly from the top plate. The upstanding perimeter wall includes an inner surface, defining an inner cavity. The transverse slot and/or entry channel is defined in the upstanding perimeter wall providing access to the inner cavity. The upper cover further includes a body and a coupling member. The body is extendable over the inner cavity defined by the upstanding perimeter. The coupling member is structurally configured to attach the upper cover to the cap member.

In some configurations, the cap member further includes each one of the transverse slot and the inner cavity, and wherein, the transverse slot includes a first portion defined in the upstanding perimeter wall on a first side of the inner cavity and a second portion defined in the upstanding perimeter wall on a second side of the inner cavity. Similarly, the entry channel is defined in the upstanding perimeter wall spaced apart from each of the first portion and the second portion of the transverse slot.

In some configurations, the upper cover further includes a mating transverse slot having a first portion that corresponds to the first portion of the transverse slot of the cap member and a second portion that corresponds to the second portion of the transverse slot of the cap member, and a mating entry channel that corresponds to the entry channel of the cap member.

In some configurations, the coupling member further comprises a first side tab and a second side tab. Each of the first side tab and the second side tab have an inward flange at a respective distal end thereof. The inward flange of the first side tab and the second side tab are structurally configured to engage a lower surface of the top plate of the cap member.

In some configurations, the body of the upper cover has an outwardly convex configuration having a plurality of openings extending therethrough.

In another aspect of the disclosure, the disclosure is directed to a method of installing a target watering and irrigation apparatus. The method comprises the steps of: providing an elongated tube; providing a cap member, the cap member having a top plate with a plurality of openings extending therethrough providing ingress into the elongated tube, and an upstanding perimeter wall defining an inner cavity; providing a hammer; installing the cap member onto the elongated tube; hitting the cap member to drive the elongated tube into the ground until top plate is substantially flush with the ground; directing an irrigation hose into the inner cavity; and coupling an upper cap to the cap member to cover the inner cavity.

In some configurations, the method further comprises the steps of: attaching a drip emitter to the irrigation hose; and positioning the drip emitter within the inner cavity prior to the step of coupling the upper cap.

### BRIEF DESCRIPTION OF THE DRAWINGS

The disclosure will now be described with reference to the drawings wherein:

FIG. 1 of the drawings is a perspective view of the target watering and irrigation apparatus of the present disclosure;

FIG. 2 of the drawings is a side elevational view of the target watering and irrigation apparatus of the present disclosure;

FIG. 3 of the drawings is a perspective view of the elongated tube of the target watering irrigation apparatus of the present disclosure;

FIG. 4 of the drawings is a cross-sectional view of the elongated tube of the target watering irrigation apparatus of the present disclosure;

FIG. 5 of the drawings is a cross-sectional view of the target watering and irrigation apparatus of the present disclosure;

FIG. 6 of the drawings is a bottom perspective view of the cap member of the target watering and irrigation apparatus of the present disclosure; and

FIG. 7 of the drawings is a side elevational view of the cap member of the target watering and irrigation apparatus of the present disclosure;

FIG. 8 of the drawings is a cross-sectional view of the apparatus of the present disclosure, showing a cap member of a second configuration with an upper cover;

FIG. 9 of the drawings is a perspective view of the apparatus of the present disclosure;

FIG. 10 of the drawings is a perspective view of the cap member with the upper cover of the present disclosure;

FIG. 11 of the drawings is a perspective view of the cap member with the upper cover of the present disclosure;

FIG. 12 of the drawings is a perspective view of the cap member of the present disclosure;

FIG. 13 of the drawings is a bottom perspective view of the cap member of the present disclosure;

FIG. 14 of the drawings is a perspective cross-sectional view of the cap member of the present disclosure;

FIG. 15 of the drawings is a perspective cross-sectional view of the cap member of the present disclosure;

FIG. 16 of the drawings is a perspective view of the upper cover of the present disclosure;

FIG. 17 of the drawings is a bottom perspective view of the upper cover of the present disclosure;

FIG. 18 of the drawings is a perspective view of the apparatus in an installed configuration;

FIG. 19 of the drawings is a perspective view of the apparatus in the installed configuration, with the upper cover removed; and

FIG. 20 of the drawings is a perspective view of the apparatus shown in FIG. 19, with the upper cover installed.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

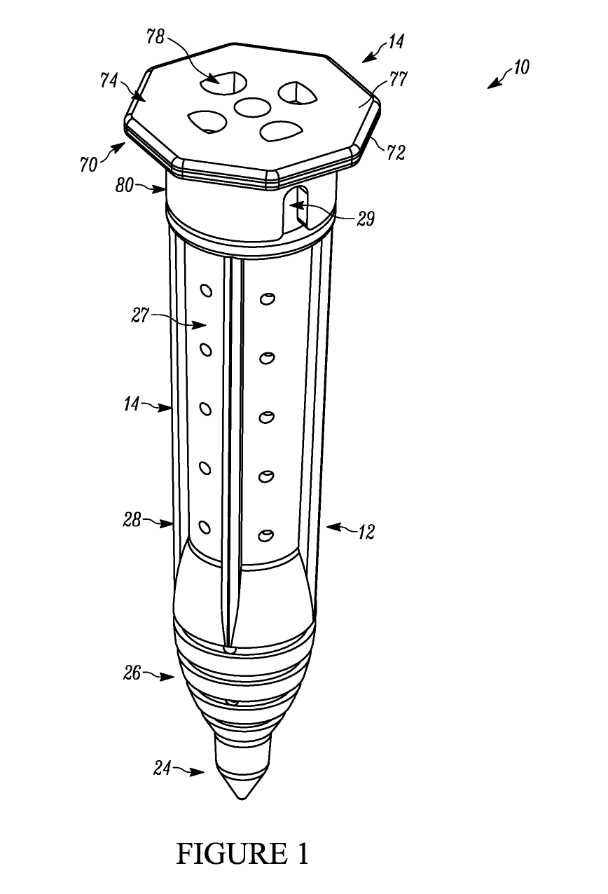

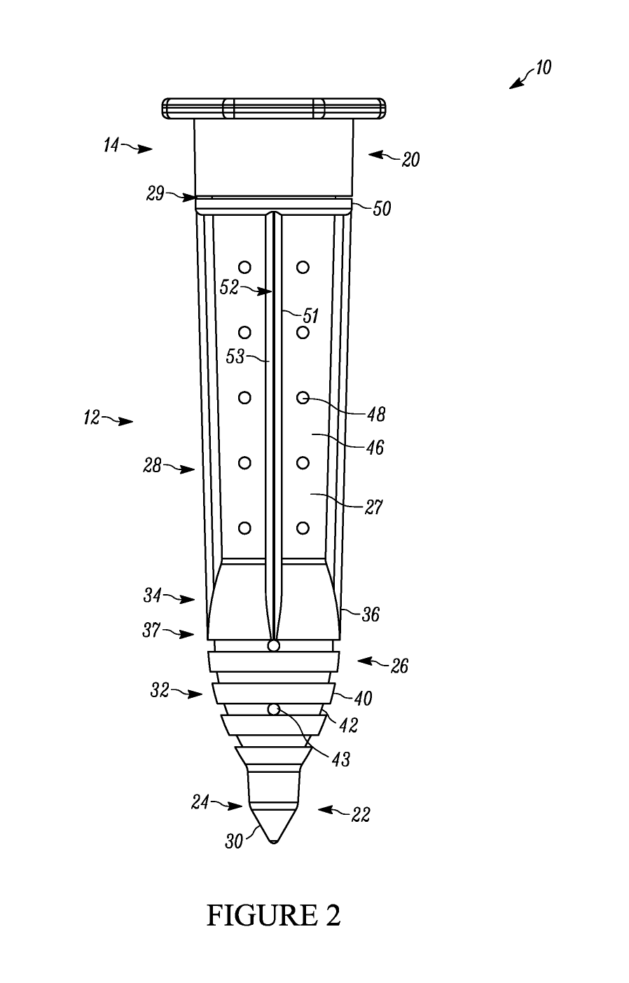

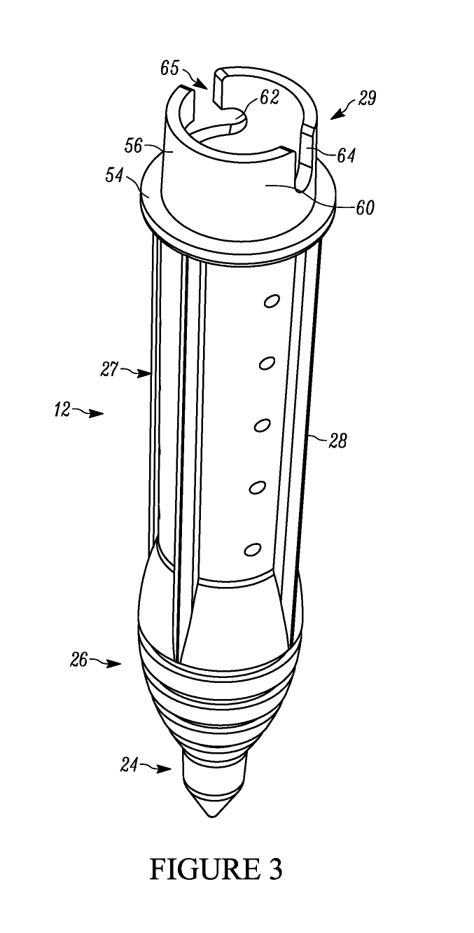

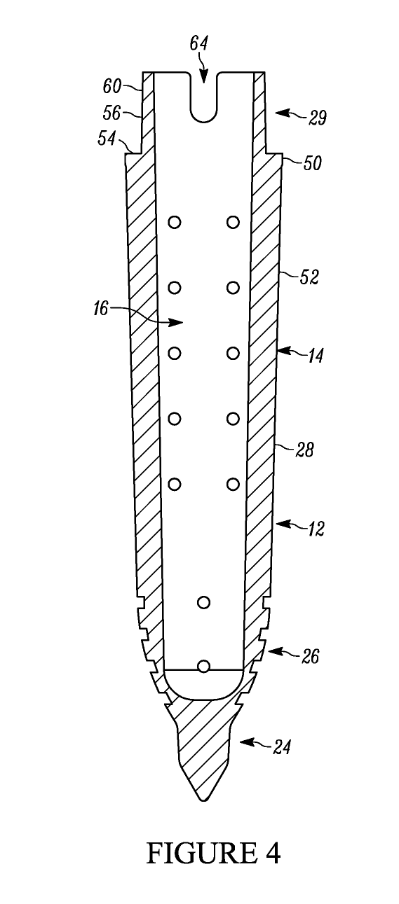

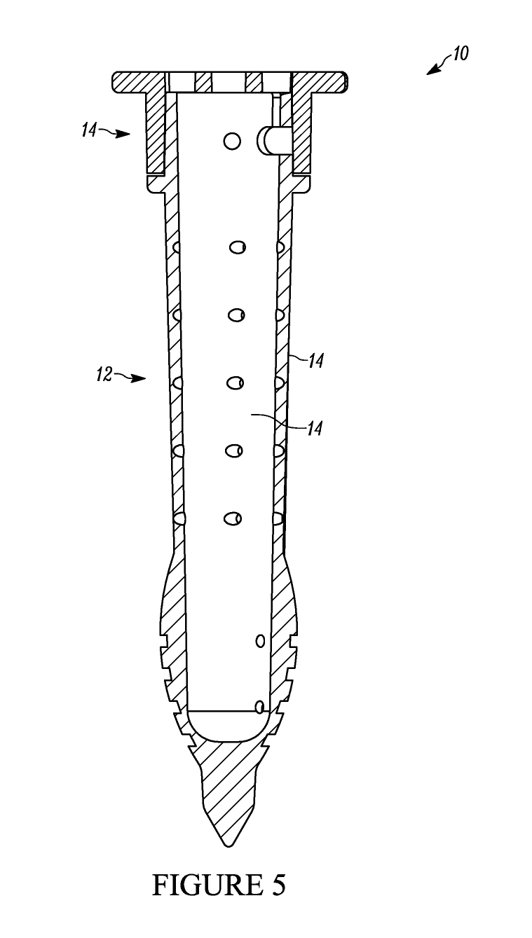

Referring now to the drawings and in particular to FIG. 1, the target watering and irrigation device is shown generally at 10 as comprising an elongated tube 12 and cap member 14. As will be explained below, the device is configured to provide water and oxygen to trees, shrubs, plants and the like, and is useful in areas wherein the soil has been compacted and such water, oxygen and nutrients fail to reach the root system of such trees, shrubs, plants and the like. Many urban areas suffer from extensive compaction of soil which limits the transmission of water, oxygen and nutrients therethrough.

The elongated tube 12 generally comprises an integrally molded member defining an outer surface 14 and an inner bore 16 which is open at an upper end 20 and closed at lower end 22. The elongated tube generally has a substantially circular or conical cross-sectional configuration that is centered on a longitudinal axis extending vertically through the bore between the upper and lower ends. It will be understood that in certain configurations, the elongated tube may comprise multiple components that are coupled together through interference fits, threaded engagement, adhesion, welding or other joining techniques. Additionally, it is contemplated that the elongated tube is generally oriented and centered so as to be substantially vertical, although variations are contemplated.

The elongated tube defines a plurality of separate portions and structures, including lower spike portion 24, bulb portion 26, shaft portion 27, support ribbing 28 and cap interface portion 29. The spike portion 24 is defined at the lower end 22 of the elongated tube 12. The bulb portion 26 extends from the spike portion, with the shaft portion and the cap interfacing portions being sequentially positioned thereafter, with the cap interfacing portion terminating at the upper end 20.

The lower spike portion 24 generally comprises tip region 30, which in the configuration shown, comprises an inverted conical configuration. It will be understood that this spike portion is configured push through the ground (often compacted) when the elongated tube is driven into the soil with a hammer, mallet or the like. It is contemplated that the bore 16 stops short of the lower spike portion, or short of a portion thereof, so that at least a portion of the lower spike portion has a solid construction with adequate strength to penetrate through the soil without failing.

The bulb portion 26 includes lower end 32, upper end 34 and outer surface 36. The bulb portion represents an elongated spherically shaped portion that has a transverse cross-sectional dimension (i.e., diameter or the like) that is wider than the shaft portion (or at least a portion thereof). The lower end 32 and the upper end 34 meet at inflection region 37. The outer surface along at least the lower end 32 includes a plurality of raised transverse ribs 40 defining at least one transverse channel 42 therebetween. In the configuration shown, the raised transverse ribs and transverse channels are substantially perpendicular to the longitudinal axis of the elongated tube. In other configurations, these may be oblique to the longitudinal axis. Additionally, the ribs and channels are shown to be substantially uniform in width, while in other configurations, these ribs may have non-uniform configurations along the circumferential surfaces thereof. Additionally, in the configuration shown, four transverse channels are shown, while it will be understood that a greater or lesser number of channels may be present. A plurality of openings 43 is disposed within the transverse channels. As will be explained below, the raised transverse ribs protect the openings from clogging during insertion and provide an improved soil condition after insertion.

In some configurations, these ribs may extend on the lower end and the upper end of the bulb portion 26. In other configurations, these ribs 40 and channels 42 are limited to the lower end 22 of the elongated tube 12. It will be understood that, in some configurations, the openings may be disposed in some or all of the transverse channels 42. In other configurations, only some of the transverse channels 42 may include openings. In still other configurations, openings may be omitted (depending on the environment of use thereof). It will further be understood that in some configurations, the raised transverse ribs and the transverse channels can be omitted from the bulb portion 26 entirely.

The shaft portion 27 extends from the bulb portion 26 and toward the upper end 20. Generally, the shaft portion can be of different lengths (depending on the depth that is required), whereas the bulb portion is preferably the same size and configuration across multiple different sizes of shaft portions. Of course, in other configurations, the overall apparatus may just be scaled in length or size depending on the application.

The shaft portion includes surface 44, and with the longitudinal support ribs 52 (described below), defines a plurality of panes, such as pane 46, which is preferably one of cylindrical and frustoconical in configuration. A plurality of openings, such as openings 48 are disposed along the surface 44. In the configuration shown, a plurality of openings extend longitudinally along at least one of the panes 46. Of course, other configurations are likewise contemplated, depending on the application, along with variations in the size of the openings. These openings provide fluid communication with the inner bore 16.

The support ribbing 28 is shown in FIG. 1 as comprising transverse ring 50 and a plurality of longitudinal support ribs, such as support rib 52, extending along the shaft portion. The ribs are generally equally spaced about the outer surface, and in this configuration shown, generally comprise a total of four ribs which are parallel to each other and which are perpendicular to the transverse ring 50. The support ribs 52 each include an upper end that joins the transverse ring and a lower end that extends into the outer surface of the bulb portion, and preferably the upper end 34 thereof. In the configuration shown, the support ribs away from the shaft portion outwardly to substantially match, or exceed the diameter of the inflection region 37. As such, the ribs have opposing side walls 51, 53 which act as sails or other impediments to preclude rotation or angled insertion of the apparatus into the ground. In the configuration shown, the longitudinal support ribs are tapered into the bulb portion 26.

It will be understood that a greater or lesser number of ribs may be utilized. In certain configurations, it may be desirable to insert the apparatus into the ground in a direction other than vertical. In such an instance, the ribs can be reconfigured to assist with the movement of the apparatus in the desired motion when inserted into the ground.

The cap interface portion 29 is positioned at the upper end 20 and is configured to matingly engage with the cap member (in one of releasable and permanent secured engagement. In the configuration shown, the cap interface portion 29 includes flange 54 and interfacing upstand wall 56. The flange 54, in the configuration shown is formed integrally with the transverse ring 50 of the support ribbing 28. The flange 54 defines the bottom interface for the cap member when installed. The interfacing upstand wall includes outer surface 60, transverse slot assembly 62 and longitudinal slot 64. As will be explained, the depending skirt 80 of the cap member 14 slidably overlyingly engages the interfacing upstand wall 56 and overlies the outer surface 60 which shape matingly and abuttingly engages the same. The slots are configured to be capable of receiving structures of the cap member, to, in turn, lock the structures together. In particular, the transverse slot assembly further includes a longitudinal introduction portion 65 which is longitudinally positioned and which intersects the transverse slot between the opposing ends. The longitudinal slot is, in the configuration shown, positioned on the opposite side of the interfacing upstand wall from the transverse slot.

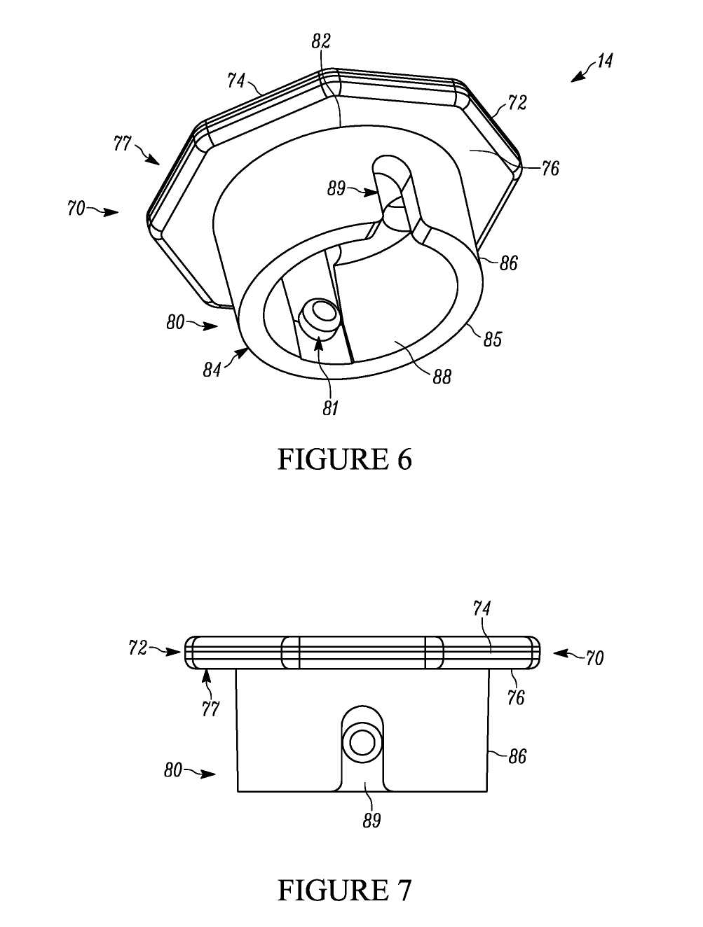

The cap member 14 is shown in FIGS. 6 and 7 as comprising top plate 70 and depending skirt 80. The top plate 70, in the configuration shown comprises a substantial planar member having a substantially uniform thickness. The top plate includes upper surface 74, lower surface 76 with openings, such as the five openings 78 extending therethrough. In the configuration shown, the top plate defines an octagonal outer perimeter 72. In other configurations, it will be understood that a greater or lesser number of openings may be utilized. It will further be understood that various topographies of the upper surface are contemplated, including dome like configurations, concave configurations, and topographies having various structural variations.

The depending skirt 80 is shown in FIG. 1 as comprising upper end 82, lower end 84, outer surface 86, inner surface 88. The upper end 82 of the depending skirt depends meets the lower surface of the top plate with the lower end 84 spaced apart therefrom. A lower rim 85 is defined at the lower end 84 of the depending skirt. The lower rim 85 interfaces with the flange 54, and, preferably the outer perimeter of the flange 54 substantially matches the outer perimeter of the depending skirt at the lower rim 85. A longitudinal slot is presented in the depending skirt, with an inward pin member 81 extending inwardly from the inner surface 88. As will be understood, the inward pin member 81 is configured to engage with one of the transverse slot and the longitudinal slot of the cap interface portion 29 of the elongated tube 12.

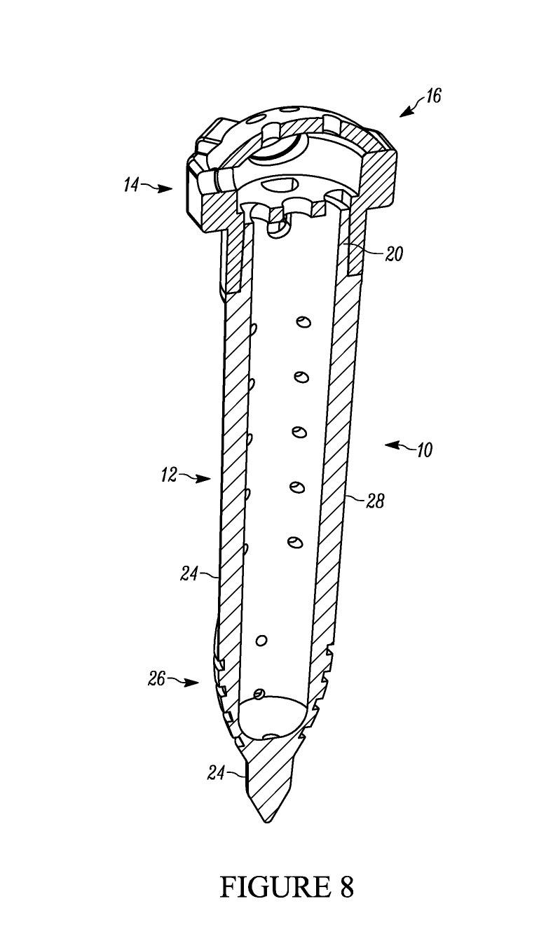

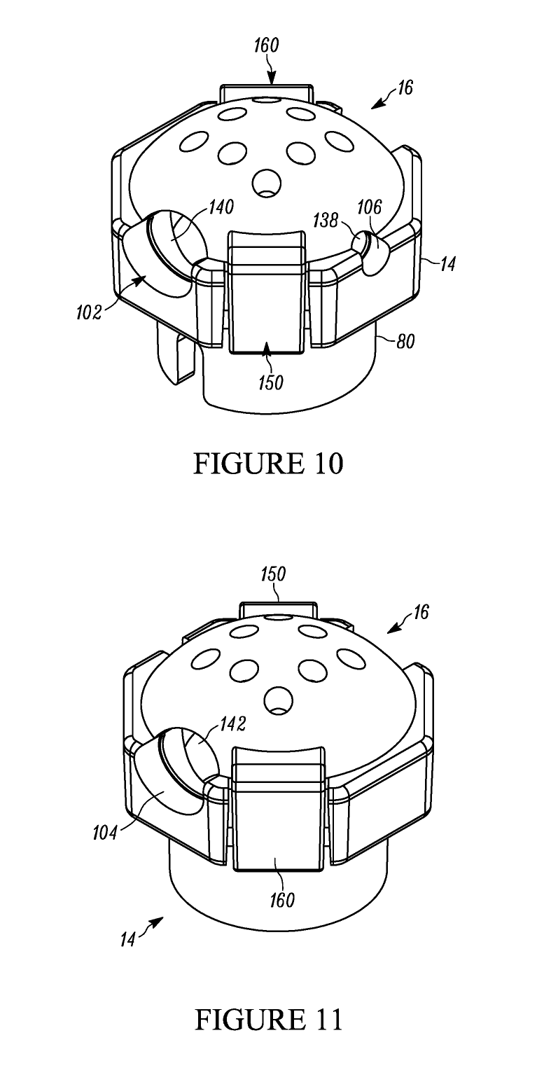

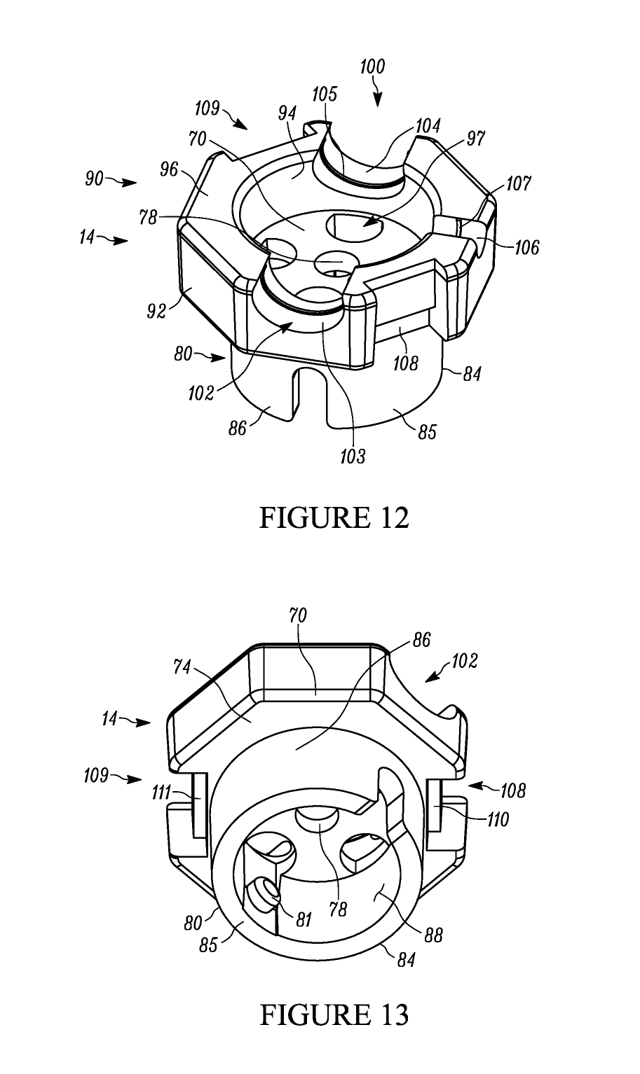

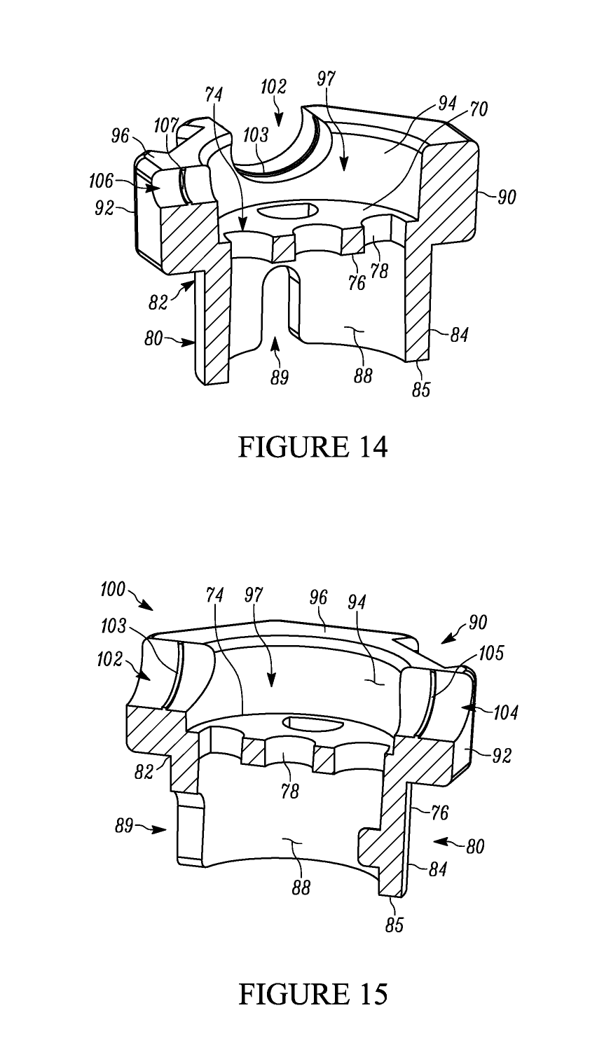

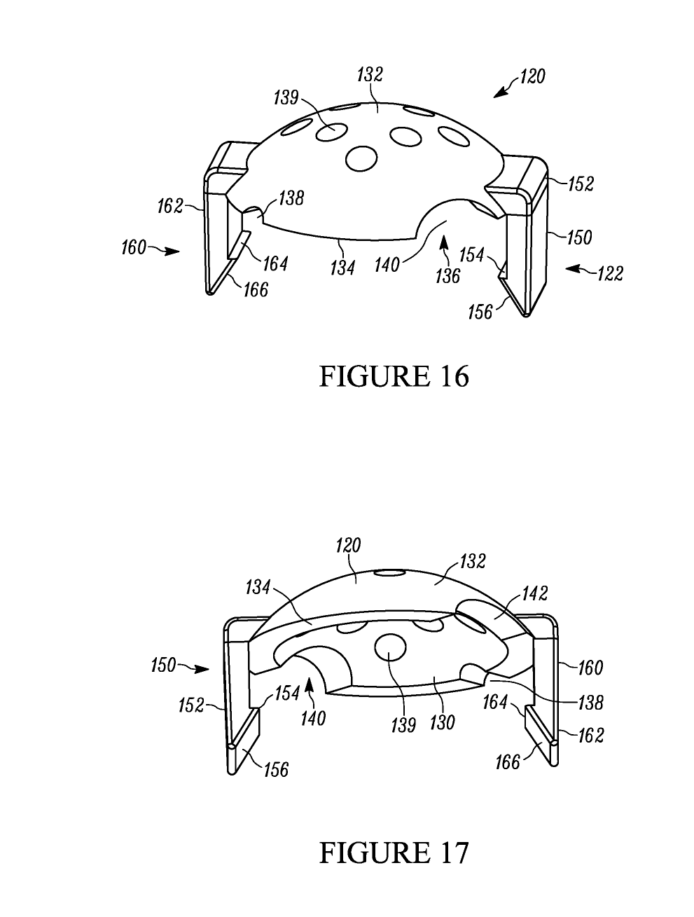

In another configuration of the target watering and irrigation apparatus, the cap member 14 may be of a different configuration, and an upper cover 16 may be provided. Such a configuration is shown in FIGS. 8 through 17. Where structures similar to those of cap 14 are disclosed, the same reference numbers will be utilized.

In such a configuration, the cap member further includes an upstanding perimeter wall 90, transverse slot 100, entry channel 106 and retaining slots 108, 109. The upstanding perimeter wall 90 includes outer surface 92, inner surface 94 and top surface 96. The upstanding perimeter wall defines inner cavity 97. In the configuration shown, the outer surface 92 comprises a substantially octagonal cross-sectional configuration that is substantially uniform, while the inner surface 94 comprises a substantially circular cross-sectional configuration that is likewise substantially uniform. It will be understood that the particular configurations are to be deemed illustrative, and not intended to limit the disclosure to the configuration shown.

The transverse slot 100 is defined in the walls by having first portion 102 and second portion 104 extending therethrough. In the configuration shown, the two portions define an axis that extends through the center of the top plate 70 and extending generally parallel to the top plate 70 in a spaced apart relationship. The first and second portions each comprise semi-circular configurations (in the configurations shown, semi-circular configurations which are in excess of 180° in radial length). A raised seal rib 103, 105 is present on each of the first and second portions 102, 104, respectively, so as to provide a retention force when the upper cover is pressed thereon and to preclude slidable movement of the hose inserted therein relative to the cap member. In the configuration shown, these structures are configured to receive and releasably retain a half inch outdoor irrigation hose. Of course, other dimensions for the transverse slot is contemplated.

The entry channel 106 is shown as being defined in the upstanding wall perimeter 90 and extending from the outer surface to the inner surface. In the configuration shown, the entry channel 106 defines an axis that is perpendicular to that defined by the transverse slot. Additionally, in the configuration shown, the entry channel 106 includes only a single portion such that the entry channel provides ingress into the cavity 97 through a singular channel defined through the upstanding perimeter wall, whereas the transverse slot defines a pass through configuration. Of course, it is contemplated that the entry channel can also have a pass through configuration. In the configuration shown, the entry channel may include a raised sealing rib 107 which aids in precluding slidable movement of a hose positioned therein after the cover member has been coupled thereto. The entry channel, in the configuration shown is structurally configured to receive an outdoor irrigation hose of one-half inch therethrough.

The retaining slots 108, 109 are defined on opposing sides of the upstanding perimeter wall and are separated by 180° from each other. They are spaced between the transverse slot and the entry channel, and extend toward the lower surface 76 of the top plate 70, with a flange 110, 111, respectively, positioned toward the lower surface. As will be explained, these slots are generally perpendicular to the top plate and ride along the outer surface of the upstanding wall perimeter to provide a path for the coupling member 122, for purposes of, among others, alignment and facilitated engagement therebetween.

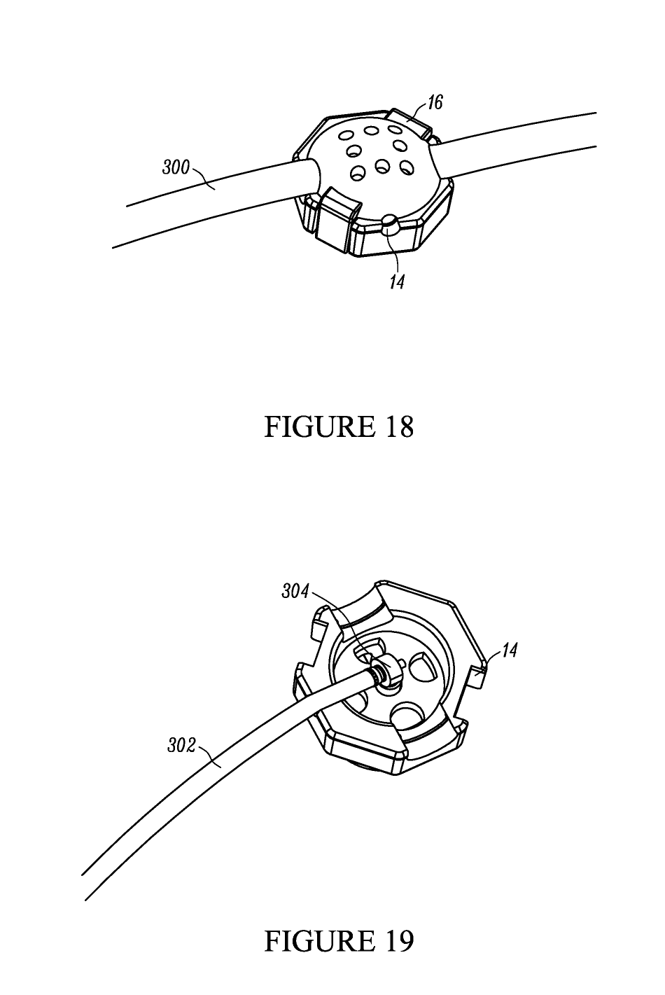

The upper cover 16 is shown in FIGS. 18 and 19 as comprising body 120 and coupling member 122. The body 120 includes inner surface 130, outer surface 132 which collectively define outer perimeter 134. In the configuration shown, the body 120 comprises an outwardly convex shape (in this particular configuration, a spherical dome configuration), with the outer perimeter comprising a circular configuration that is generally, when installed, matingly abuttable to the top surface 96 of the upstanding perimeter wall. A plurality of openings, such as openings 139, are defined through the body 120.

A mating transverse slot 136 is defined in the body 120 as first portion 140 and second portion 142. The first portion, spatially, corresponds to the first portion 102 of the transverse slot 100 when in the installed configuration (i.e., completing the generally circular configuration therebetween to match a hose for an outdoor irrigation system). Similarly, the second portion 142 corresponds to the second portion 104 of the transverse slot 100. Similarly, a mating entry channel 138 is defined in the body 120 that corresponds, spatially, to the entry channel 106 of the cap member 14 when in the installed configuration.

The coupling member 122 includes first side tab 150 and second side tab 160, generally positioned opposite of the first side tab 150. The first side tab 150 includes a depending portion 152 that depends from the outer perimeter 134. The depending portion includes an inner inclined ramp 156 at a distal end thereof, and on an inner surface thereof, that terminates at an inward flange 154. Similarly, the second side tab 160 includes a depending portion 162 that depends from the outer perimeter 134. The depending portion includes an inner inclined ramp 166 at a distal end thereof, and on an inner surface thereof, that terminates at an inward flange 164. In the configuration shown, the first and second side tabs are generally mirror images of each other taken about an axis that extends through the center of the upper cover bisecting the same. It will be understood that, in the configuration shown, the first side tab and the second side tab interface with the retaining slots 108, 109, respectively, and their interaction will be described hereinbelow.

To assemble the apparatus 10, the cap member 14 is coupled to the elongated tube 12. In particular, the depending skirt 80 is directed so that the cap interface portion 29 can be matingly directed into the cavity formed by the depending skirt 80. When interfaced, the two are oriented relative to each other so that the inward pin member 81 of the depending skirt extends into the introduction 65, and, eventually into the transverse slot 62. Once fully inserted, the two can be rotated relative to each other so that the inward pin member 81 is directed to one end of the longitudinal slot 89. The two components are then coupled to each other. In other configurations, in the place of the slots and pin member, the two components may be threaded together, or they may be adhered together. In still other configurations, the two structures may be simply press fit together.

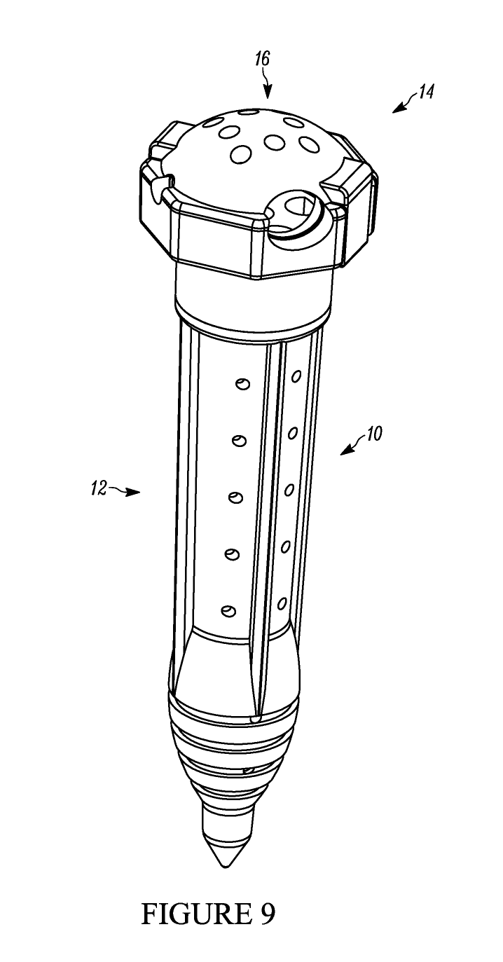

With the configuration of the cap member 14 and the upper cover 16 of FIGS. 9 through 19, the coupling to the elongated tube is substantially the same. However, the upper cover is configured to be snapped onto the cap member. To achieve the same, the user positions the upper cover 16 in overlying position over the cap member, with the first side tab 150 overlying the retaining slot 108 and with the second side tab 160 overlying the retaining slot 109. As the structures are directed toward and into contact, the tabs enter into the slots, and the slots contact the inclined ramps 156, 166 directing the tabs outwardly and elastically deforming the tabs outwardly (i.e., in a stressed or biased configuration). Continued coupling directs the tabs along the slots until the inward flanges 154, 164 extend beyond the corresponding flanges 110, 111 associated with the slots in the upstanding perimeter wall, at which time, the tabs return inwardly toward their unstressed position, whereby the inward flanges interface with the lower surface of these corresponding flanges 110, 111 and removal is substantially precluded. Of course, the tabs can be urged outwardly until the inward flanges release from the lower surface of the corresponding flanges 110, 111 and then the upper cover can be disconnected from the cap member.

In operation, the user decides where the target watering and irrigation apparatus 10 will be positioned. Once determined, the user can place the lower spike portion 24 on the surface of the ground. While holding the shaft or bulb portion of the elongated tube 12, the user can tap the upper surface 74 with a hammer or mallet to drive the elongated tube into the ground. The thickness of the members and the reinforced structure (i.e., the support ribbing) precludes collapsing and other damage when being driven into the ground.

Interestingly, while being inserted into the ground, as the bulb portion has a larger cross-section than the shaft portion, and in particular, the panes of the shaft portion, the bulb pushes soil away, and as a result, the soil that eventually surrounds the shaft portion is looser (as it was loosened by the passage of the relatively larger bulb). Preferably, the shaft portion can, for example, comprise three quarters of the length of the elongated tube, and this three quarters of length will have loose soil therearound than the bulb portion, as the bulb portion forged a larger opening for the shaft portion. Moreover, as the bulb portion is larger than the shaft portion generally, and preferably, about the entire outer perimeter, substantially the entirety of the soil around the shaft portion will be loose as compared to the surrounding soil. This also protects the openings on the shaft portion from being clogged due to the insertion. Moreover, the support ribbing, and in particular the longitudinal support ribs generally direct the elongated body in a vertical direction, precluding tilting and rotating of the elongated body as the body is being driven into the ground.

It will further be understood that the lower end of the bulb portion pierces through the ground, utilizing the raised transverse ribs and the transverse channels to protect the openings 43 disposed thereon, so as to preclude the openings form being clogged. The openings are also shielded from damage that may be caused by rocks or other structures that can be encountered when the apparatus is driven into the ground. It will further be understood that the bulb portion may have the openings omitted therefrom so that the bulb portion can define a reservoir for the retention of water which can then pass through evaporation. In other configurations, the openings in the bulb portion can be smaller than the other openings (or may comprise small perforations or seams) to allow for a relatively slower release of water.

Due to the openings on the top plate, water and oxygen from the top of the ground is directed by way of gravity into the inner bore, and distributed through the openings 43 and the openings 48 to the surrounding soil. Advantageously, the nutrients, water and oxygen can be directed to the roots, whereas such materials have difficulty reaching the root system in a compacted soil.

Additionally, in either of the configurations shown, a relatively small (i.e., quarter inch or the like, typically) outdoor irrigation hose can be directed through the longitudinal slot 89 of the cap member and the corresponding longitudinal slot 64 of the cap interfacing portion 29.

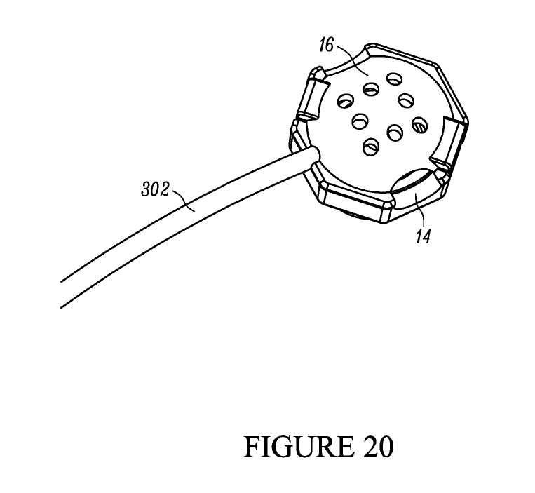

In the configuration of FIGS. 9 through 19, the combination of the upper cover 16 and the cap member 14 facilitate the coupling with, or the inclusion of, for example, drip emitters and/or hoses that can terminate or pass through the inner cavity 97. In particular, and with reference to FIG. 20, a drip line 300, such as a one half inch drip line for an outdoor irrigation system can be positioned into the transverse slot 100 and can be captured therein by snapping the upper cover thereover. The raised sealing ribs 103, 105 preclude slidable movement between the hose and the apparatus by elastically (and/or plastically) deforming the hose to preclude slidable movement therebetween.

With reference to FIGS. 21 and 22, in another configuration or layout, a relatively smaller outdoor irrigation hose 302 can be positioned into the entry channel and when the upper cover is snapped into engagement, the hose can be captured between the entry channel and the mating entry channel. As with the raised sealing ribs 103, 105, the raised sealing rib 107 can limit relative slidable movement between the hose and the apparatus.

With continued reference to FIGS. 21 and 22, a drip emitter 304 can be coupled to the end of the hose and placed within the inner cavity 97. When the upper cover 16 is coupled, the drip emitter is captured within the inner cavity 97. Due to the configuration of the inner cavity, and the convex configuration of the body 120 of the upper cover, a drip emitter of, for example, a three quarter inch size can be coupled to the end of the hose, that, in the configuration shown, comprises a one quarter inch hose.

Of course, in other configurations, it will be understood that other size hoses and other types of outdoor irrigation accessories may be incorporated in and through the apparatus, in the place of drip line and drip emitters. For example, an inline drip emitter may be spliced into the hose that extends through the transverse slot, or a drip emitter can be pushed into an opening in the hose.

Furthermore, with the openings through the upper cover, additional surface water (from rain or other sources) can be directed into the elongated tube and can be directed through by gravity toward the tip region to provide water directly to roots and the like.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A target watering and irrigation apparatus comprising:
an elongated tube having an outer surface and an inner bore;
a cap member positioned over the upper end of the inner bore, the cap member having at least one opening in communication with the inner bore.

2. The apparatus of claim 1 wherein the elongated tube further includes an upper end and a lower end, with a bulb portion positioned at the lower end and a shaft portion positioned between the bulb portion and the upper end.

3. The apparatus of claim 2 wherein the shaft portion includes at least one pane having openings, the bulb portion having an outer surface that extends radially beyond at least a portion of the pane having openings.

4. The apparatus of claim 3 wherein the shaft portion includes at least one longitudinal support rib extending along the shaft portion between the bulb portion and the upper end, the at least one longitudinal support rib having opposing side walls projecting outwardly from the at least one pane.

5. The apparatus of claim 4 wherein the shaft portion includes a plurality of longitudinal support ribs positioned in a spaced apart relationship.

6. The apparatus of claim 3 wherein the bulb portion includes a plurality of openings, with the openings of the pane being larger than the openings of the bulb portion.

7. The apparatus of claim 6 wherein the bulb portion includes at least one transverse channel opposed by raised transverse ribs, with the plurality of openings extending through the at least one transverse channel.

8. The apparatus of claim 3 further comprising a lower spike portion positioned between the bulb portion and the lower end.

9. The apparatus of claim 2 wherein the bulb portion includes an inflection point that is spaced apart from the lower end and spaced apart from the lower spike portion.

10. The apparatus of claim 1 wherein the cap member further comprises a top plate that is generally perpendicular to an axis defined by the elongated tube, with a depending skirt structurally configured to matingly interface with the elongated tube proximate the upper end thereof with the top plate having a plurality of openings extending therethrough to provide ingress into the elongated tube.

11. The apparatus of claim 10 wherein the top plate extends radially outwardly beyond the depending skirt.

12. The apparatus of claim 11 wherein the depending skirt extends about the outer surface of the elongated tube.

13. The apparatus of claim 12 wherein the elongated tube further includes a flange space apart from the upper end thereof and extending axially outward from the outer surface thereof, the flange abutting a lower rim of the depending skirt, limiting further slidable movement thereof relative to the elongated tube.

14. The apparatus of claim 10 wherein the cap member is releasably coupled to the elongated tube to as to preclude relative axial movement.

15. The apparatus of claim 14 wherein the cap member further includes an inward pin that is interfaceable with a transverse slot in the elongated tube.

16. The apparatus of claim 10 further comprising an upper cover, the cap member further comprising:
an upstanding perimeter wall extending upwardly from the top plate, the upstanding perimeter wall including an inner surface, defining an inner cavity; and
at least one of a transverse slot and an entry channel defined in the upstanding perimeter wall providing access to the inner cavity;
the upper cover further comprising:
a body extendable over the inner cavity defined by the upstanding perimeter; and
a coupling member structurally configured to attach the upper cover to the cap member.

17. The apparatus of claim 16 wherein the cap member further includes each one of the transverse slot and the inner cavity, and wherein,
the transverse slot includes a first portion defined in the upstanding perimeter wall on a first side of the inner cavity and a second portion defined in the upstanding perimeter wall on a second side of the inner cavity; and
the entry channel is defined in the upstanding perimeter wall spaced apart from each of the first portion and the second portion of the transverse slot.

18. The apparatus of claim 17 wherein the upper cover further includes a mating transverse slot having a first portion that corresponds to the first portion of the transverse slot of the cap member and a second portion that corresponds to the second portion of the transverse slot of the cap member, and a mating entry channel that corresponds to the entry channel of the cap member.

19. The apparatus of claim 16 wherein the coupling member further comprises a first side tab and a second side tab, each of the first side tab and the second side tab having an inward flange at a respective distal end thereof, with the inward flange of the first side tab and the second side tab structurally configured to engage a lower surface of the top plate of the cap member.

20. The apparatus of claim 16 wherein the body of the upper cover has an outwardly convex configuration having a plurality of openings extending therethrough.

21. A method of installing a target watering and irrigation apparatus, the method comprising the steps of:
providing an elongated tube;
providing a cap member, the cap member having a top plate with a plurality of openings extending therethrough providing ingress into the elongated tube, and an upstanding perimeter wall defining an inner cavity;
providing a hammer;
installing the cap member onto the elongated tube;
hitting the cap member to drive the elongated tube into the ground until top plate is substantially flush with the ground;
directing an irrigation hose into the inner cavity; and
coupling an upper cap to the cap member to cover the inner cavity.

22. The method of claim 21 further comprising the steps of:
attaching a drip emitter to the irrigation hose; and
positioning the drip emitter within the inner cavity prior to the step of coupling the upper cap.
